(19) United States
(12) Patent Application Publication
(10) Pub. No.: US 2016/0156212 A1
(43) Pub. Date: Jun. 2, 2016

(54) BATTERY CONTROL CIRCUIT AND ELECTRONIC DEVICE

(71) Applicant: HON HAI PRECISION INDUSTRY CO., LTD., New Taipei (TW)

(72) Inventors: HUNG-YI WANG, New Taipei (TW); PO-ERH SHIH, New Taipei (TW)

(21) Appl. No.: 14/669,998

(22) Filed: Mar. 26, 2015

(30) Foreign Application Priority Data
Dec. 2, 2014 (TW) 103141725

(51) Int. Cl. H02J 7/00

(52) U.S. Cl. CPC H02J 7/0063; H02J 2007/0067

(57) ABSTRACT

A battery control circuit includes a pulse controller, a first FET, a second FET, an inductor and a capacitor. The pulse controller includes a first and a second driving port. The gate electrode of the first FET is connected to the first driving port. The drain electrode of the first FET is connected to a battery. The gate electrode of the second FET is connected to the second driving port. The source electrode of the second FET is grounded. The drain electrode of the second FET is connected the source electrode of the first FET. The inductor is connected between the source electrode of the first FET and the capacitor. A power port is connected to a connection of the capacitor and the inductor. The pulse controller controls the first and second driving port to output pulse signal alternatively, to alternatively switch on the first and second FET.

### FIELD

The subject matter herein generally relates to a battery control circuit and an electronic device with the battery control circuit.

### BACKGROUND

A battery is generally used in an electronic device, such as a notebook, to supply power for the electronic device when an adapter is not used.

### BRIEF DESCRIPTION OF THE DRAWINGS

Implementations of the present technology will now be described, by way of example only, with reference to the attached figures.

FIG. 1 is a block diagram of an embodiment of an electronic device with a battery control circuit and an external battery.

FIG. 2 is a circuit diagram of an embodiment of the battery control circuit of FIG. 1.

FIG. 3 is a signal timing diagram of the battery control circuit of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape or other feature that the term modifies, such that the component need not be exact. For example, “substantially cylindrical” means that the object resembles a cylinder, but can have one or more deviations from a true cylinder. The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

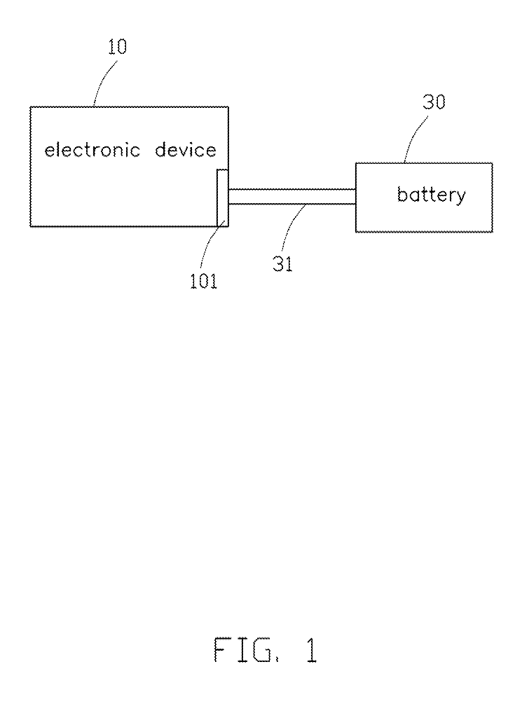

FIG. 1 illustrates an embodiment of an electronic device 10 and an external battery 30. In at least one embodiment, the electronic device 10 is a notebook and includes an interface 101, and the battery 30 is coupled to the electronic device 10 via a cable 31 or a connector.

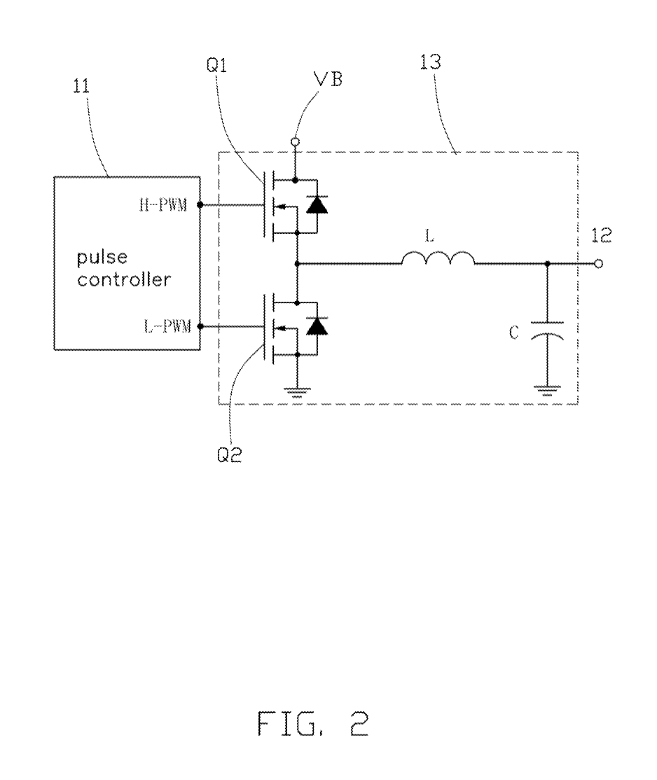

FIG. 2 illustrates the electronic device 10 including a battery control circuit. The battery control circuit can include a pulse controller 11 and a voltage regulation circuit 13. The voltage regulation circuit 13 can include a first field effect transistor (FET) Q1, a second FET Q2, an inductor L, and a capacitor C. The pulse controller 11 has first driving port H-PWM and a second driving port L-PWM. The first driving port H-PWM is configured to output a first pulse signal, the second driving port L-PWM is configured to output a second pulse signal. The first pulse signal and the second pulse signal have the same frequency but opposite phases. The first pulse signal and the second pulse signal are alternate.

Each of the first FET Q1 and the second FET Q2 is N type. The first driving port H-PWM is coupled to the gate electrode of the first FET Q1. The second driving port L-PWM is coupled to the gate electrode of the second FET Q2. The battery 30 is capable of outputting a battery power VB to supply an operation voltage to power the electronic device 100. The battery 30 is coupled to the drain electrode of the first FET Q1. The source electrode of the first FET Q1 is coupled to a first port of the inductor L. A second port of the inductor L is grounded via a capacitor C. A power port 12 is coupled to a connection of the inductor L and the capacitor C. The drain electrode of the second FET Q2 is coupled to the source electrode of the first FET Q1. The source electrode of the second FET Q2 is grounded.

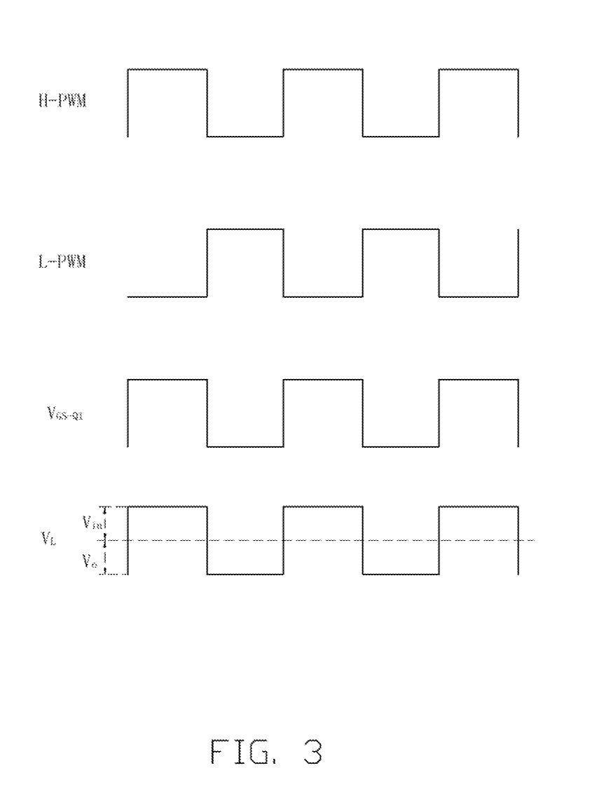

FIG. 2 and FIG. 3 illustrate that when the battery 30 powers the electronic device 10, the pulse controller 11 controls the first driving port H-PWM and the second driving port L-PWM to output pulse signals alternatively. When the first driving port H-PWM outputs a logic high level signal, the second driving port L-PWM outputs an empty signal, the first FET Q1 is switched on, the second FET Q2 is switched off, and the first FET Q1 divides the battery voltage VB with the power port 12. The power port 12 outputs a first power voltage V1, and the battery voltage VB charges the capacitor C via the first FET Q1 and the inductor L.

When the second driving port L-PWM outputs a logic high level signal, the first driving port H-PWM outputs an empty signal, the second FET Q2 is switched on, the first FET Q1 is switched off, because the voltage of two ports of each of the inductor L and the capacitor C cannot be suddenly changed, the power port outputs a second power voltage V2.

The value of the second power voltage V2 is related to a duty ratio of the first pulse signal. The value of the second power voltage V2 is substantially equal to a formula VB*D/(1−D), thus the second power voltage V2 can be equal to first power voltage V1 by adjusting the duty ratio of the first pulse signal. The first power voltage V1 and the second power voltage V2 are capable of charging or powering another device (not shown).

When the battery 30 is exhausted, the pulse controller 11 controls the second FET Q2 to be switched on and the first FET Q1 switched off, the power port 12 is coupled to a power supply (not shown) to charge the capacitor C via the second FET Q2 and the inductor L. When the first FET Q1 is switched on, and the second FET Q2 is switched off, because the voltage of two ports of each of the inductor L and the capacitor C cannot be suddenly changed, the power port 12 charges the battery 30 via the first FET Q1.

The embodiments shown and described above are only examples. Many details are often found in the art such as the other features of a battery control circuit and an electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A battery control circuit comprising:
a pulse controller having a first driving port and a second driving port;
a first field effect transistor (FET) having a first FET gate electrode, a first FET drain electrode and first FET source electrode, with the first FET gate electrode connected to the pulse controller first driving port and the first FET drain electrode is connectable to a battery;
a second FET having a second FET gate electrode, a second FET drain electrode and a second FET source electrode, the second FET gate electrode is connected to the pulse controller second driving port, the second FET source electrode is grounded and the second FET drain electrode is connected to the first FET source electrode;
an inductor with a first end connected to the second FET drain electrode and the first FET source electrode;
a capacitor having a first end connected to a second end of the inductor with a second end of the capacitor being grounded; and
a power port connected to the second end of the inductor and the first end of the capacitor;
wherein, the pulse controller outputs a pulse signal alternatively from the first driving port and the second driving port; and
wherein, the pulse signal outputted by the pulse controller alternatively activates the first FET and the second FET.

2. The battery control circuit of claim 1, wherein when the battery is charged, the capacitor and the inductor are powered via the power port when the second FET is switched on, and the capacitor and the inductor charge the battery when the first FET is switched on.

3. The battery control circuit of claim 2, wherein when the battery charges out, the battery charges the capacitor and the inductor when the first FET is switched on, and the capacitor and the inductor charge the power port when the second FET is switched on.

4. The battery control circuit of claim 3, wherein when the capacitor and the inductor charge the power port, the power port outputs a power voltage, and the value of the power voltage is proportional to a duty ratio of the pulse signal output from the first driving port.

5. The battery control circuit of claim 1, wherein each of the first FET and the second FET is N typed FET.

6. A battery control circuit comprising:
a pulse controller comprising a first driving port and a second driving port;
a first field effect transistor (FET);
a second FET;
an inductor; and
a capacitor;
wherein, the gate electrode of the first FET is coupled to the first driving port; the drain electrode of the first FET is coupled to a battery; the gate electrode of the second FET is coupled to the second driving port; the source electrode of the second FET is grounded; the drain electrode of the second FET is coupled to the source electrode of the first FET; the inductor is coupled between the source electrode of the first FET and the capacitor; the capacitor is grounded; a power port is coupled to a connection of the capacitor and the inductor; and the pulse controller controls the first driving port and the second driving port to output pulse signal alternatively, to alternatively switch on the first FET and the second FET;
wherein, when the battery is charged, the capacitor and the inductor are powered via the power port when the second FET is switched on, and the capacitor and the inductor charge the battery when the first FET is switched on;
wherein, when the battery charges out, the battery charges the capacitor and the inductor when the first FET is switched on, and the capacitor and the inductor charge the power port when the second FET is switched on.

7. The battery control circuit of claim 6, wherein when the capacitor and the inductor charge the power port, the power port outputs a power voltage, and the value of the power voltage is proportional to a duty ratio of the pulse signal output from the first driving port.

8. The battery control circuit of claim 6, wherein each of the first FET and the second FET is N typed FET.

9. An electronic device, comprising:
an interface;
a battery coupled to the interface; and a
a battery control circuit comprising:
a pulse controller comprising a first driving port and a second driving port;
a first field effect transistor (FET);
a second FET;
an inductor; and
a capacitor;
wherein, the gate electrode of the first FET is coupled to the first driving port; the drain electrode of the first FET is coupled to the battery; the gate electrode of the second FET is coupled to the second driving port; the source electrode of the second FET is grounded; the drain electrode of the second FET is coupled to the source electrode of the first FET; the inductor is coupled between the source electrode of the first FET and the capacitor; the capacitor is grounded; a power port is coupled to a connection of the capacitor and the inductor; and the pulse controller controls the first driving port and the second driving port to output pulse signal alternatively, to alternatively switch on the first FET and the second FET.

10. The electronic device of claim 9, wherein when the battery is charged, the capacitor and the inductor are powered via the power port when the second FET is switched on, and the capacitor and the inductor charge the battery when the first FET is switched on.

11. The electronic device of claim 10, wherein when the battery charges out, the battery charges the capacitor and the inductor when the first FET is switched on, and the capacitor and the inductor charge the power port when the second FET is switched on.

12. The electronic device of claim 11, wherein when the capacitor and the inductor charge the power port, the power port outputs a power voltage, and the value of the power voltage is proportional to a duty ratio of the pulse signal output from the first driving port.

13. The electronic device of claim 9, wherein each of the first FET and the second FET is N typed FET.
